(19) United States
(12) Patent Application Publication
(10) Pub. No.: US 2015/0112894 A1
(43) Pub. Date: Apr. 23, 2015

(54) PERSPECTIVES FOR PREDICTIVE ANALYSIS

(71) Applicant: Harish Kumar Lingappa, Bangalore (IN)

(72) Inventor: Harish Kumar Lingappa, Bangalore (IN)

(21) Appl. No.: 14/061,627

(22) Filed: Oct. 23, 2013

(51) Int. Cl. G06N 5/04

(52) U.S. Cl. CPC G06N 5/04
USPC 706/11; 706/46

(57) ABSTRACT

A perspective selection may be used to identify one or more algorithms that may be of interest to an end user and that are associated with the selected perspective. The perspective selection may be used to determine an algorithm for the predicted data of interest and to determine the relevant data for the determined algorithm to generate the predicted data. The relevant data may be retrieved from a backend system and used with the determined algorithm to generate the predicted data. The predicted data may be output to a client device to display a visualization of the predicted data for easy consumption by an end user.

### BACKGROUND

Entities, such as businesses, may utilize backend systems to store big data. Such data may be used, in some instances, for analysis and/or reporting for the entity about the performance of the entity. Such data may be used in predictive analysis to make predictions or projections using the current and historical data stored in the backend systems. Predictive analysis utilizes predictive models that may be adapted for the specific application, such as a sales forecasting predictive model, a supply chain usage predictive model, etc.

### SUMMARY

One embodiment of the invention relates to a method for generating predicted data based on a perspective selection. The method may include receiving, at a processing module, a perspective selection from a client device. One or more algorithms to generate predictive data may be determined based, at least in part, on the perspective selection. Relevant data may be determined based, at least in part, on the determined one or more algorithms. The relevant data may be retrieved from a backend system, and predicted data may be generated using the one or more algorithms and the retrieved relevant data.

In another implementation, a system includes a processing module and a non-transitory computer-readable storage device storing instructions that, when executed by the processing module, cause the processing module to perform several operations. The operations include receiving a first perspective selection from a client device. The perspective selection may correspond to a role in a business. A first algorithm to generate first predictive data may be determined based, at least in part, on the first perspective selection and relevant data may be determined based, at least in part, on the determined first algorithm. The relevant data may be retrieved from a backend system and first predicted data may be generated using the determined first algorithm and the retrieved relevant data. The generated first predicted data may be stored in a predictive analysis data store.

In yet a further implementation, a non-transitory computer-readable storage device may store instructions that, when executed by a processing module, cause the processing module to perform several operations. The operations may include receiving a perspective selection from a client device. The operations may further include determining an algorithm to generate predictive data based, at least in part, on the perspective selection. Relevant data may be determined based, at least in part, on the determined algorithm. The relevant data may be retrieved from a backend system. The retrieval of the relevant data from the backend system may include identifying a view of a virtual data model module associated with the relevant data. Predicted data may be generated using the determined algorithm and the retrieved relevant data.

### BRIEF DESCRIPTION OF THE DRAWINGS

Various embodiments taught herein are illustrated by way of example, and not by way of limitation, in the figures of the accompanying drawings, in which:

FIG. 1 is an overview block diagram of an example system for providing perspectives for predictive analysis;

FIG. 2 is a block diagram of an example backend system;

FIG. 3 is a process diagram for an example system providing perspectives for predictive analysis;

FIG. 4 is a flow diagram of an example method for selecting a perspective for predictive analysis at the client device and receiving outputted predicted values;

FIG. 5 is a flow diagram of an example method for receiving a selection of a perspective for predictive analysis from the client device and providing predicted values based on a corresponding algorithm and data;

FIG. 6 is a block diagram depicting an example hierarchy of perspectives;

FIG. 7 is an overview of an example visualization that may be generated based on the outputted predicted values;

FIG. 8 is an overview of another example visualization that may be generated based on the outputted predicted values;

FIG. 9 is an overview of still another example visualization that may be generated based on the outputted predicted values;

FIG. 10 is an overview of yet another example visualization that may be generated based on the outputted predicted values; and

FIG. 11 is a block diagram illustrating an architecture for a computer system that may be employed to implement various elements of the systems and methods.

It will be recognized that some or all of the figures are schematic representations for purposes of illustration only. The figures are provided for the purpose of illustrating one or more implementations with the explicit understanding that they will not be used to limit the scope or the meaning of the claims.

### DETAILED DESCRIPTION

The following is merely provided for example purposes with the explicit understanding that the examples described herein will not be used to limit the scope or the meaning of the claims.

1. Overview

Entities, such as businesses, utilize data in a variety of ways. For example, businesses may collect and integrate business data into business databases and/or data warehouses and report or otherwise utilize the data using business software. In some instances, such business data is utilized by data scientists with predictive algorithms to generate predicted data based on current and/or historical data. Such data scientists, with the assistance of information technology professionals, help organize and use predictive algorithms to generate analytical reports based on the predictions. The data scientists identify a suitable algorithm and the corresponding data stored in a database of a backend system for requested predicted data. A plethora of algorithms exist for a wide variety of predicted data. Thus, such predictive analysis requires an intermediary between the end user and the underlying algorithms and data. Currently, predictive analysis tools are not designed for end users and such tools require a greater understanding of the underlying algorithms to arrive at the desired predictive data.

Accordingly, it may be useful to provide a system that can simplify the identification of an appropriate algorithm and underlying data such that an end user may generate the predicted data without the need for an intermediary. The implementation of a perspective (e.g., “Salesperson,” “Human Resources Person,” “Sales Executive,” “Supplier,” “Customer Service Executive,” “CEO,” “CTO,” “CFO,” “COO,” “Financial Planner,” etc.) may substantially narrow the scope of the possible algorithms and corresponding relevant data to be used for the desired predicted data. In some implementations, the perspective may correspond to a role in a business. Once the perspective is selected by the end user, in some implementations, the database from which the underlying data for the algorithm may be known, such as by views that may be part of a database accessing product, such as SAP®'s HANA Analytics Foundation product. The database schema information of a backend database, such as SAP®'s Business Warehouse, may be exposed to as part of the SAP® HANA Analytics Foundation product to give access to the entire business warehouse database of with meaningful names and relations between the tables. The perspectives may be correlated with the meaningful names and relations to access the underlying tables of data.

In some implementations, options for several different kinds of predicted data may be presented from which the end user may select. For example, a “Salesperson” perspective may have options for predicted data, such as “Sales Forecast,” “Buying Trend by Association,” “Sales Cluster Analysis,” etc., which is related to the perspective selected. In addition, the options may also be modified based on other aspects, such as “Sales Forecasting by Year,” “Sales Forecasting by Quarter,” “Sales Forecasting by Product,” “Sales Forecasting by Salesperson,” etc. Based on the perspective and the selected option, the appropriate algorithm and corresponding data may be selected to generate the desired predicted data without having a deep understanding of each algorithm that may be used. Thus, analytical charts with predictions based on the predicted data may be generated in a straight-forward and simple manner by an end user based on the selection of the perspective and the particular option of predicted data in which the end user is interested. In some instances, the end user may further customize the analytical charts and/or reports, such as limiting by dates, regions, products, facilities, persons, etc.

In some implementations, the end user may switch to another perspective, which can provide further insight. Using the prior example, if an end user initially selects the “Salesperson” perspective and generates predicted data for “Sales Forecast,” then switching perspectives to, for example, “Supplier” may generate predicted data for how much inventory is required to support the predicted sales previously generated. In another example, if the end user switches to a perspective of “CEO,” then predicted data for cost versus profit and forecasts of revenue or margin may be generated. Such dual perspectives permit an end user to receive a multi-dimensional view of the predicted data to further enhance their understanding of the predicted data they receive and/or how it fits into the business's objectives overall.

An example of systems and methods for implementing the foregoing will now be described in greater detail.

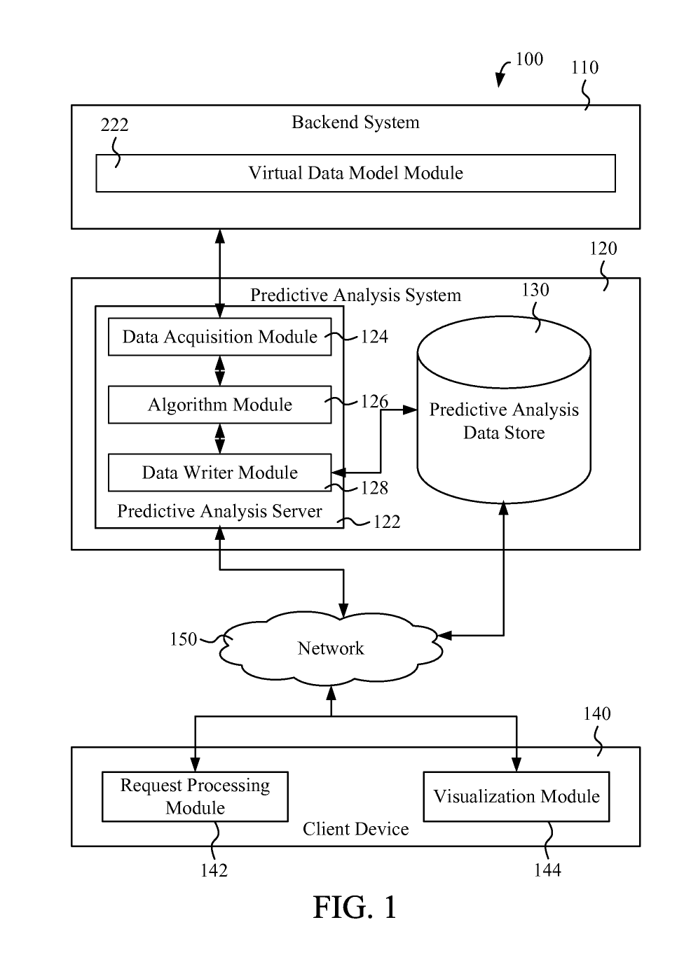

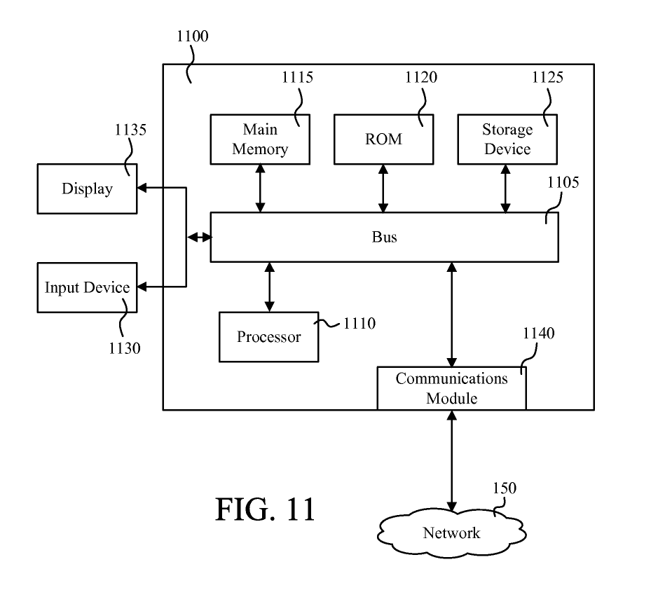

FIG. 1 depicts an example system 100 for providing predicted data based on perspectives for predictive analysis. The system 100 includes a backend system 110, a predictive analysis system 120, and a client device 140. The predictive analysis system 120 and the client device 140 are in communication via a network 150. The backend system 110 of the present example comprises a server or collection of servers that include a virtual data model module 222. The server or servers of the backend system 110 may be a computing device, such as computing device 1100 of FIG. 11, and/or the server or servers may be configured otherwise. In some instances, the backend system 110 may comprise several computing devices, such as a cloud server, etc. The virtual data model module 222 includes several virtual data models via views to access and utilize underlying stored data, as will be described in greater detail herein.

The predictive analysis system 120 is in communication with the backend system 110 to acquire data from the views of the virtual data model module 222 in a data store of the backend system 110. In some implementations, the predictive analysis system 120 and the backend system 110 may be part of the same system or may be separate systems. The predictive analysis system 120 includes a predictive analysis server 122 and a predictive analysis data store 130. The predictive analysis server 122 may be a server or several servers. In some instances, the predictive analysis server 122 may comprise several computing devices, such as a cloud server, etc. The predictive analysis server 122 is communicatively coupled to the predictive analysis data store 130 to transmit, store, and/or receive data. The predictive analysis data store 130 may be local to the predictive analysis server 122 or may be remote from the predictive analysis server 122. The predictive analysis data store 130 of the present example may comprise a separate computing device, several computing devices, a tangible computer-readable data storage device, several tangible computer-readable data storage devices, etc. The predictive analysis data store 130 is configured to store data, such as predicted data, and/or other data. In the present example, the predictive analysis data store 130 stores predicted data or values such that a visualization module 144 of the client device 140 can retrieve the predicted data or values to present an end user with appropriate reports/visualizations. Such predicted data or values may be used for business analytics and/or other purposes.

The predictive analysis server 122 includes a data acquisition module 124, an algorithm module 126, and a data writer module 128. The data acquisition module 124 is configured to acquire data from the views of the virtual data model module 222 in a data store of the backend system 110 that can be used with an algorithm determined by the algorithm module 126 to present the end user with predicted reports based on the requested perspective of the end user. In the present example, the data acquisition module 124 is configured to determine and retrieve the corresponding data from the backend system 110 based on the algorithm determined by the algorithm module 126.

The algorithm module 126 contains set of all possible algorithms which may be used for perspective analysis to generate appropriate reports for the end user based on the perspective which is selected. The algorithm module 126 is configured to receive a perspective selection from the user of the client device 140 and to determine one or more corresponding algorithms based on the selected perspective. In some implementations, such as when several algorithms may be applicable for the selected perspective, the algorithm module 126 may be further configured to output one or more options to the client device 140 for selection by the end user to determine the applicable algorithm. Once the algorithm is determined by the algorithm module 126, then the algorithm module 126 interacts with the data acquisition module 124 to request the corresponding data from the backend system 110. The algorithm module 126 is further configured to utilize the determined algorithm and the corresponding data to generate predicted data or values, such as, for example, sale projection predicted data, etc.

The data writer module 128 is configured to receive the predicted data from the algorithm module 126 and to save or otherwise store the predicted values in the predictive analysis data store 130 such that the visualization module 144 of the client device 140 can use the predicted data and present the end user with appropriate reports/visualizations. The data writer module 128 may be further configured to associate a unique identifier, such as an alphanumeric value, with the predicted data such that the predicted data may be identified and retrieved. As will be described in greater detail below, the data writer module 128 may be further configured to retrieve the predicted data from the predictive analysis data store 130 for use with a second algorithm based on the selection of a second perspective by an end user.

The predictive analysis system 120 may also include a communications module, such as communications module 1140 of FIG. 11, for providing a communication link between the predictive analysis system 120 and the network 150. As such, the communications module enables the predictive analysis system 120 to communicate, wired or wirelessly, with other electronic systems, such as client device 140, in communication with the network 150. For instance, the communications module may be coupled to an Ethernet line that connects the predictive analysis system 120 to the Internet or another network 150. In other implementations, the communications module may be coupled to an antenna and provides functionality to transmit and receive information over a wireless communication interface with the network 150.

The client device 140 may be a computing device, such as computing device 1100 of FIG. 11. The client device 140 may include a user interface for accessing and/or otherwise interacting with the predictive analysis system 120. For example, the user interface may be provided by a local application, a web application, and/or any other method for allowing a user of the client device 140 to provide input and receive output from the predictive analysis system 140. In one implementation, the user interface may be provided via an application executing on the client device 140. In another implementation, the user interface may be provided via HTML5 or JavaScript on a web browser of the client device 140. Of course other ways of providing a user interface may be implemented as well.

The client device 140 includes a request processing module 142 and a visualization module 144. The request processing module 142 is configured to receive the perspective selection from the end user and send the selected perspective to the predictive analysis server 122. The request processing module 142 is further configured to receive the predicted data or values that are generated by the predicted analysis server 122. In some implementations, the request processing module 142 may retrieve the predicted data or values from the predicted analysis data store 130. The visualization module 144 is configured to use the predicted values to create or generate a visualization using the predicted data and displays the visualization on a display of the client device 140 to the end user.

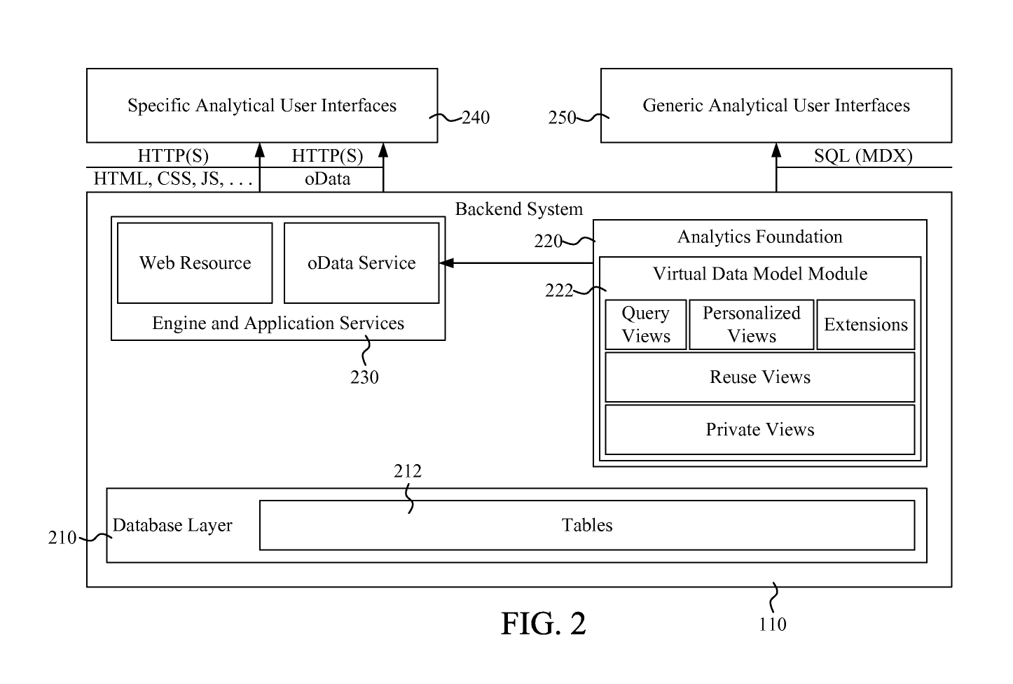

FIG. 2 depicts a more detailed view of the backend system 110. The backend system 110 includes a database layer 210, an analytics foundation 220, and engine and application services 230. The database layer 210 includes the underlying data tables 212 in which the data to be used for the predictive analysis is stored. In some implementations, the database layer 210 may include business data stored in one or more data tables 212 and in one or more computer-readable storage devices. The database layer 210 may include a business data warehouse, such as SAP®'s Business Warehouse solution. The data tables 212 may include tables containing sales information, product information for the sales, inventory information for making the products, supplier information for entities that sell the inventory to make the products, raw material cost for the supplier, etc.

The analytics foundation 220 is configured to access the data tables 212 of the database layer 210. The analytics foundation 220 includes a virtual data model module 222 that is configured with several views to access the underlying data stored in the data tables 212. In the example shown, the virtual data model module 222 includes private views, reuse views, query views, personalized views, and extensions. The views are configured such that, when a particular view is selected, the analytics foundation 220 access the corresponding data tables 212 to retrieve the data to be presented to the end user in accordance with the selected view. Thus, the virtual data model module 220 can hide the complexity and customizing dependencies of the various data models for the views while making data of the data tables 212 available to an end user without needing a deep understanding of underlying data tables 212. The database schema information of the data tables 212 may be exposed as part of the analytics foundation 220 to provide access to the entire database of the database layer 210 with meaningful names provided by the various views and the relations between the data tables 212. In some implementations, the analytics foundation 220 may be the HANA Analytic Foundation offered by SAP®.

The engine and application services 230 include the analytics computing engine to perform analytics on high data volumes to permit deep levels of detail using the underlying data stored in the data tables 212. In the example shown, the engine and application services 230 include web resources and Open Data Protocol (oData) services to permit an end user to interact with the backend system 110 via a web interface and/or through another application. In some implementations, specific analytical user interfaces 240 may be provided for an end user to interact with the backend system 110. Such specific analytical user interfaces 240 may be web-based user interfaces that may be configured using HyperText Markup Language HTML), HTML5, Cascading Style Sheets (CSS), JavaScript®, etc. In some implementations, the specific analytical user interfaces 240 may use oData to access and/or interact with the backend system 110. In other implementations, the specific analytical user interfaces 240 may use SQL to access and/or interact with the backend system 110. The specific analytical user interfaces 240 may be customized to provide a business-specific and/or user-specific interface. In other implementations, generic analytical user interfaces 250 may be provided for an end user to interact with the backend system 110 such that other business software or third-party software may interact with the backend system 110. In the present example, the backend system 110 may be the HANA platform offered by SAP®.

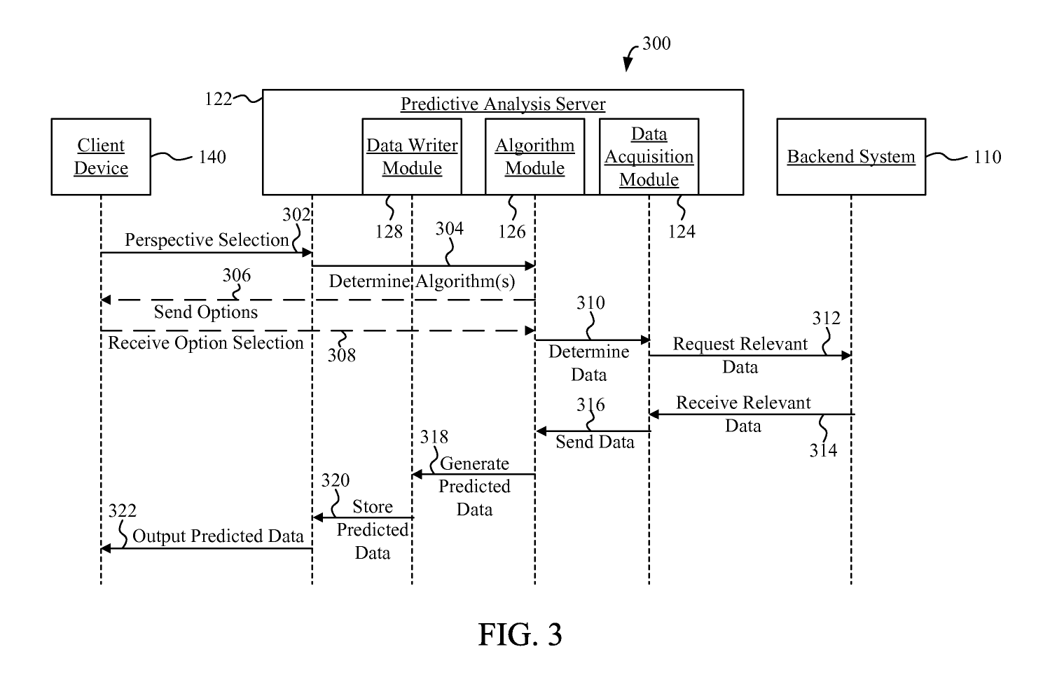

FIG. 3 depicts an example process diagram depicting an example process 300 for providing predicted data to a client device 140 using a selected perspective. In the example shown, the client device 140 receives a user's selection of a perspective through a user interface displayed on a display of the client device 140. In some implementations, several perspectives may be presented to the user to select from through a drop-down menu feature, a radio button selection feature, or other user interface features. Once the perspective is selected by the user, the request processing module 142 of the client device sends the selected perspective 302 to the predictive analysis server 122. In an example, the selected perspective may be a string, such as “salesperson,” or the selected perspective may simply be a numerical value associated with the corresponding perspective.

The predictive analysis server 122 uses the algorithm module 126 to determine one or more algorithms 304 based on the selected perspective. The algorithm module 126 may include all the algorithms that may be utilized by an end user and may have each algorithm associated with a corresponding perspective. Accordingly, when the selected perspective is received by the predictive analysis server 122, the algorithm module 126 determines the corresponding algorithm or algorithms based on the received selected perspective.

In some implementations, the predictive analysis server 122 may send one or more options 306 to the client device 140 if several algorithms are applicable for the selected perspective. For example, algorithms for sales forecasting, determining buying trends by association, providing sales cluster analysis, and/or other algorithms may be provided as options from which the end user may select based on a “salesperson” selected perspective. The options may be presented to the end user via a user interface provided on the client device 140 such that the end user may select an option of the set of options. The selected option may be sent 308 to the algorithm module 126 of the predictive analysis server 122 such that the corresponding algorithm may be determined based on the selected option.

The algorithm module 126 then uses the data acquisition module 124 to determine the relevant data for the determined algorithm 310. In some implementations, the relevant data for each algorithm may be associated with the algorithm via a data structure correlating the relevant data with each algorithm. The data acquisition module 124 requests the relevant data 312 from the backend system 110. In some implementations, the data acquisition module 124 may send a request for the corresponding view(s) of the virtual data model module 222. The analytics foundation 220, having the virtual data model module 222, accesses the relevant data tables 212 and provides the relevant data to the data acquisition module 124.

The data acquisition module 124 receives the relevant data 314 and then sends the data 316 to the algorithm module 126 to be used with the algorithm. The appropriate algorithm required to generate the predicted data is executed automatically by the algorithm module 126 of the predictive analysis server 122 and the predicted data or values are generated 318. The predicted data or values that are generated as the output of the executed algorithm are provided to the data writer module 128 to be stored 320 in the predictive analysis data store 130.

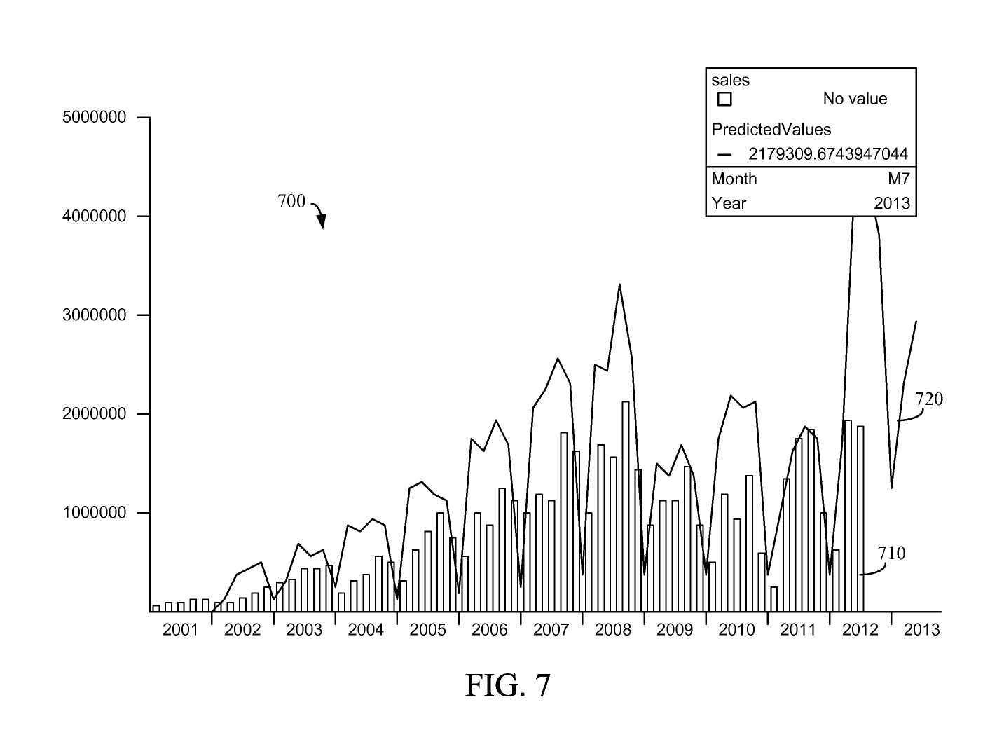

In some implementations, the predicted data or values may be output 322 to the client device 140 once the predicted data is stored in the predictive analysis data store 130. In other implementations, the request processing module 142 of the client device 140 may be sent a notification that the prediction data or values are ready to be used in an appropriate visualization to be displayed to the end user. The request processing module 142 may then activate the visualization module 144 to prepare and/or display a chart, line graph, pie chart, clusters, etc. to the end user with the predicted data or values. In some implementations, the underlying data may also be used with the predicted values to provide additional context to the predicted values. Examples of such visualizations are depicted in FIGS. 7-10.

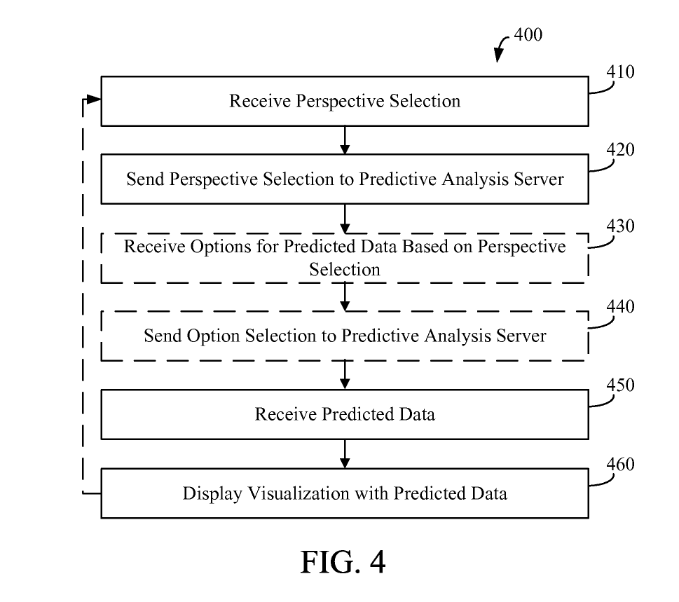

FIG. 4 depicts a flow diagram of an example method 400 for selecting a perspective for predictive analysis at the client device 140 and receiving outputted predicted values. The method 400 includes receiving a perspective selection (block 410). The client device 140 receives a user's selection of a perspective through interaction with a user interface displayed on a display of the client device 140. In some implementations, several perspectives may be presented to the user to select from through a drop-down menu feature, a radio button selection feature, or other user interface features. In an example, the selected perspective may be a string, such as “salesperson,” or the selected perspective may simply be a numerical value associated with the corresponding perspective.

Once the perspective is selected by the user, the request processing module 142 of the client device sends the selected perspective to the predictive analysis server 122 (block 420). In some implementations, such as a web-based user interface, the sending of the perspective selection to the predictive analysis server 122 may be a POST request method to transmit the perspective selection to the predictive analysis server 122. The perspective selection enables the predictive analysis server 122 to request the appropriate view of the virtual data model module 222 of the analytics foundation 220 will be used.

In some instances, such as where a selected perspective may be associated with several applicable algorithms, the client device 140 may receive options for predicted data based on the perspective selection (block 430). For example, algorithms for sales forecasting, determining buying trends by association, providing sales cluster analysis, sales opportunity prediction, and/or other algorithms may be provided as options from which the end user may select based on a “salesperson” selected perspective. Thus, the options may correspond to a type of query that the end user is interested in (e.g., forecasting, clustering, etc.). The options may be presented to the end user via a user interface provided on the client device 140 such that the end user may select an option of the set of options. The selected option is sent to the algorithm module 126 of the predictive analysis server 122 (block 440) such that the corresponding algorithm may be determined based on the selected option.

The predictive analysis server 122 uses the selected perspective and, optionally, the selected option or query type to generate predicted data. The predicted data is then received by the client device 140 (block 450). In some implementations, the request processing module 142 receives a notification that the predicted data is available in the predictive analysis data store 130 and the visualization module 144 may retrieve the predicted data to generate a visualization. The visualization is then displayed with the predicted data (block 460).

In some implementations, the end user may select another perspective (e.g., returning to block 410) that is different from the original perspective. The second perspective may be sent to the predictive analysis server to determine one or more algorithms that are applicable for the second perspective. In one example, the second perspective may be that of “supplier.” An example of an algorithm that may be applicable for a “supplier” perspective may be forecasting materials needed. In some implementations, the predicted data used for sales forecasting for the prior “salesperson” perspective may be used, at least in part, with the algorithm for forecasting materials. Predicted data for the materials needed based on the prior forecasting of sales may then be generated. Thus, while an end user may only be authorized to view certain data, the end user may be permitted to switch between multiple selected perspectives to view the data from different aspects, thereby gaining a deeper understanding of the predicted data and the impact of the predicted data.

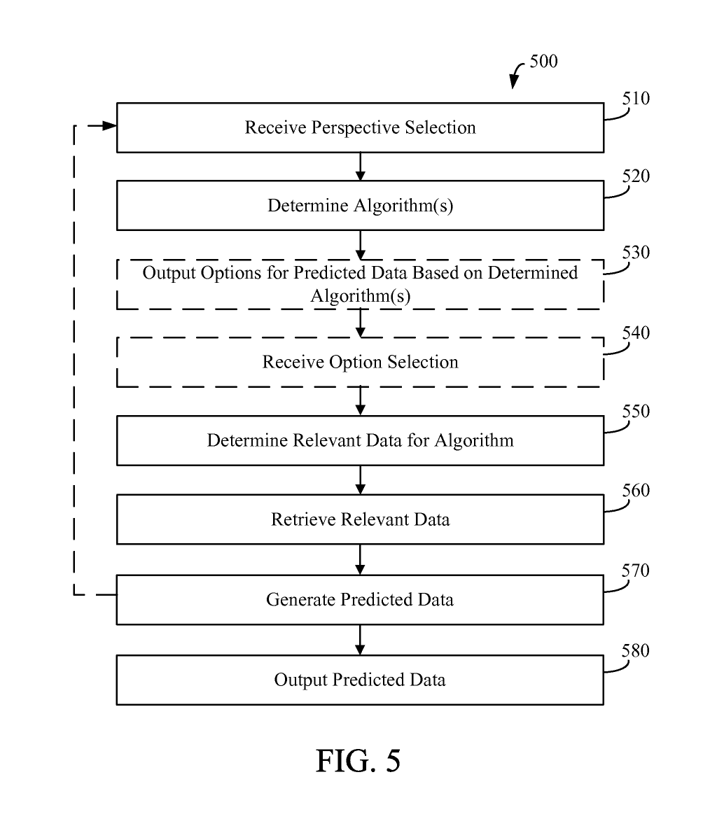

FIG. 5 depicts a flow diagram of an example method 500 for the predictive analysis server 122 to receive a selection of a perspective for predictive analysis from the client device 140 and provide predicted values based on a corresponding algorithm and data. The predictive analysis server 122 receives a perspective selection (block 510) from a client device 140. Based on the received perspective selection, the algorithm module 126 of the predictive analysis server 122 determines one or more algorithms (block 520) that are applicable for the selected perspective. In some implementations, the predictive analysis server 122 may be able to determine the corresponding algorithm and the relevant data based directly on the received perspective selection. In other implementations, the predictive analysis server 122 may output one or more options to the client device 140 based on the determined algorithm(s) for the selected perspective (block 530). Such options may correspond to a type of query that the end user is interested in (e.g., forecasting, clustering, etc.) for the selected perspective.

The predictive analysis server 122 receives a selected option block 540) from the client device 140 and then determines which algorithm from the determined one or more algorithms is to be used for the selected perspective and option.

The data acquisition module 124 determines the relevant data for the determined algorithm (block 550). The relevant data for each algorithm may be associated with the algorithm via a data structure correlating the relevant data with each algorithm. The data acquisition module 124 retrieves the relevant data from the backend system 110 (block 560). In some implementations, the data acquisition module 124 may send a request for the corresponding view(s) of the virtual data model module 222 of the backend system 110. The analytics foundation 220, having the virtual data model module 222, accesses the relevant data tables 212 and provides the relevant data to the data acquisition module 124.

The algorithm module 126 of the predictive analysis server 122 generates the predicted data using the determined algorithm and the retrieved relevant data (block 570). The predicted data or values that are generated as the output of the executed algorithm are provided to the data writer module 128 to be stored in the predictive analysis data store 130 or, in some implementations, the predicted data or values may be output (block 580) to the client device 140. The predicted data or values may then be used to generate a visualization or otherwise display the predicted data or values to the end user in a meaningful way,

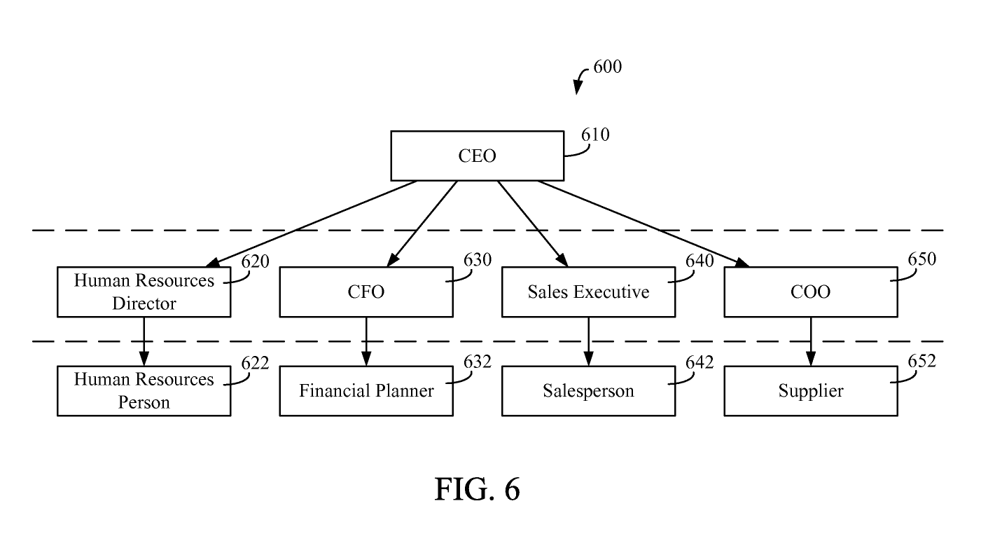

While the foregoing has generally described the processes and methods for generating predicted data based on a perspective selection, in some implementations, it may useful to provide a hierarchy of perspectives based on the data an end user is authorized to view. FIG. 6 depicts an example hierarchy 600 for various perspectives. In the example shown, a perspective for CEO 610 is provided at the top level. A perspective for Human Resources Director 620, CFO 630, Sales Executive 640, and COO 650 are provided in a second level below the top level. Perspectives for Human Resources Person 622, Financial Planner 632, Salesperson 642, and Supplier 652 are provided in a third level below the second level and depend from a corresponding second level perspective (e.g., Human Resources Person 622 depends from the Human Resources Director 620). Each perspective is authorized to view and access corresponding data stored in the data tables 212 of the backend system 110. In addition, each perspective is associated with one or more algorithms. As noted above, the Salesperson 642 perspective may be associated with algorithms for sales forecasting, determining buying trends by association, providing sales cluster analysis, and/or other algorithms associated with the Salesperson perspective 642.

In addition to each perspective being authorized to view and access corresponding data for that perspective, perspectives that are higher in the hierarchy 600 can view and access any data that a lower perspective is authorized to view and access. For example, the CEO 610 may view and access any data authorized for any of the other perspectives. In another example, the Human Resources Director 620 can view and access any data authorized for the Human Resources Person 622. In some implementations, perspectives may be limited to viewing and accessing the data for those perspectives that depend from the higher perspective. For example, the Human Resources Director 620 may be permitted to view and access the data authorized for the Human Resources Person 622, but may not be permitted to view and access the data authorized for the Financial Planner 632. Perspectives that are lower or on the same level in the hierarchy 600 can select a perspective that is higher in the hierarchy 600, but can only utilize the data that the lower perspective is authorized to view and access.

While the data that each perspective may be authorized to access may be limited based on the hierarchy, one or more of the algorithms that are associated with a higher or same level perspective may be permitted to be accessed by a perspective that is lower or equal in the hierarchy 600. For example, a salesperson end user may select the perspective of CEO 610, but the salesperson end user may only be permitted to access certain data. Such limited access may limit the algorithms that may be available to a salesperson end user when the perspective of CEO 610 is selected. For example, an algorithm for predicted profits and revenues may be available, but the relevant data that may be used with the algorithm may be limited to the data regarding the salesperson's particular region and/or products. An algorithm for generating predicted profit margins by facility may not be available to the salesperson end user as the relevant data may not be available based on the authorizations. Thus, end users having authorizations for lower perspectives may still access and utilize some aspects of perspectives that are higher in the hierarchy 600, but are limited by the data that the end user is permitted to access.

FIGS. 7-10 depict examples of several visualizations 700, 800, 900, 1000 that may be generated using the visualization module 144 of the client device 140 based on the generated predicted data from the predictive analysis server 122. FIG. 7 depicts an example visualization 700 for sales forecasting from a “salesperson” selected perspective that depicts the prior historical relevant data 710 displayed with predicted data 720 for sales based on the prior relevant data 710 stored in the data tables 212 of the backend system 110. The predicted data 720 for sales is generated using an algorithm determined based on the selected perspective of “salesperson.” The relevant data is retrieved from the backend system 110 to be inputted into the algorithm to generate the predicted data 720 for sales. The predicted data 720 for sales is output to the client device 140 or retrieved by the client device 140 from the predictive analysis data store 130 such that the visualization module 144 may generate the visualization 700 shown.

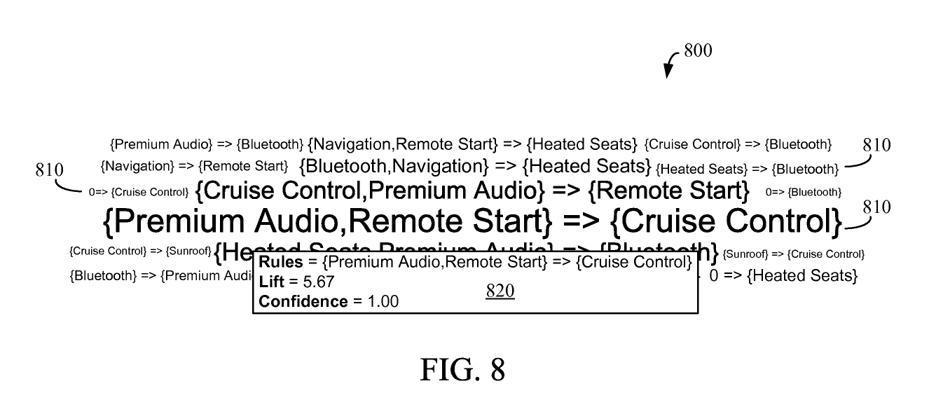

FIG. 8 depicts another visualization 800 that may be generated for sales opportunity prediction for optional features for vehicle sales. In the example shown, several correlated features 810 and corresponding confidence (e.g., based on opacity of the displayed features) are shown in a cluster based on an algorithm configured to determine, using sales information, which features are selected with other features. The features on the left of each correlation 810 correspond to those features that, based on the predicted data from the algorithm, drive the sale of the feature on the right of the correlation 810. The larger the size of the displayed correlated features 810, the greater the number of sales for the feature on the right. In addition, the darker the display of the correlated features 810, the greater the confidence interval is that the features on the left assist in sales of the feature on the right. In the implementation shown, when a mouse-over is detected by the visualization module 144 of the client device 140, additional information 820 may be displayed in a pop-up display to depict the rules for the correlation 810, the lift for the correlation 810 based on the predicted data and the confidence interval of the correlation 810.

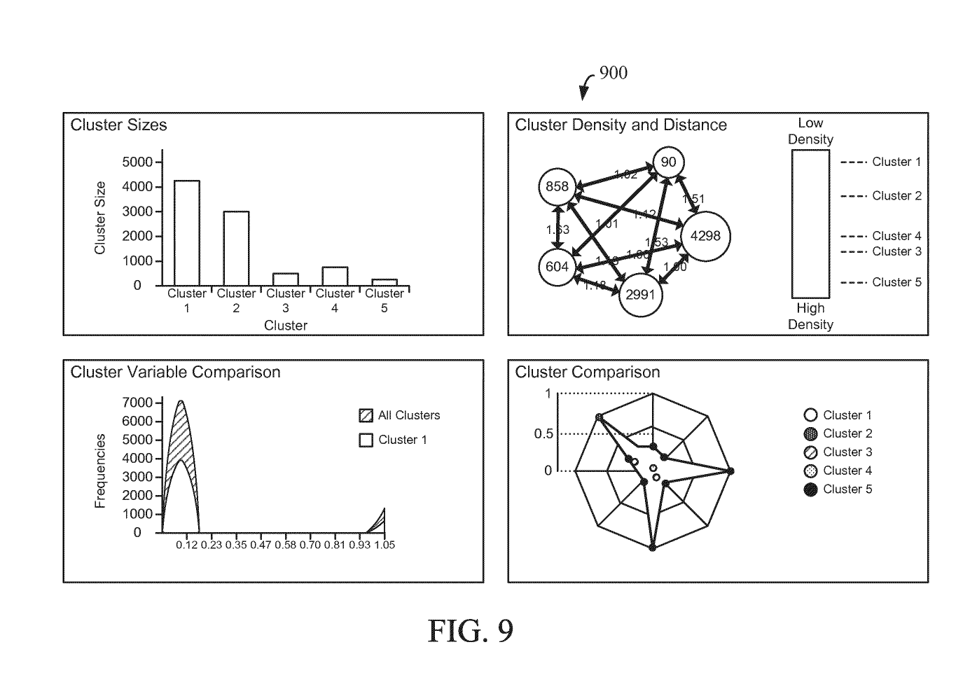

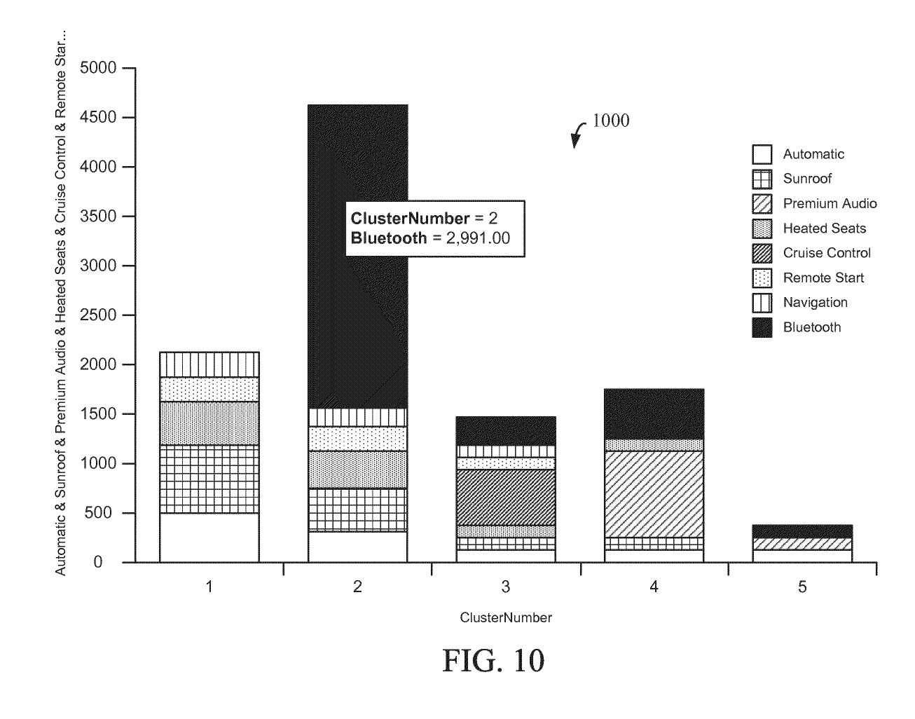

FIGS. 9-10 depicts visualizations 900, 100 for a sales cluster analysis for optional features for vehicle sales. Visualization 900 depicts a set of visualizations using generated predicted data for clusters of optional features including the cluster size, cluster density and distance relative to other clusters, cluster variable comparison, and a cluster comparison. Visualization 1000 depicts the composition of optional features in each cluster. In the example shown, the data indicates that a Bluetooth optional feature is an important part of the top-selling option cluster while a premium audio optional feature is a part of a less popular option cluster.

FIG. 11 is a block diagram of a computer system 1100 that can be used to implement the client device 140, the predictive analysis server 1122, the backend system 110, and/or any other computing device described herein. The computing system 1100 includes a bus 1105 or other communication component for communicating information and a processor 1110 or processing module coupled to the bus 1105 for processing information. The computing system 1100 also includes main memory 1115, such as a RAM or other dynamic storage device, coupled to the bus 1105 for storing information, and instructions to be executed by the processor 1110. Main memory 1115 can also be used for storing position information, temporary variables, or other intermediate information during execution of instructions by the processor 1110. The computing system 1100 may further include a ROM 1120 or other static storage device coupled to the bus 1105 for storing static information and instructions for the processor 1110. A storage device 1125, such as a solid state device, magnetic disk or optical disk, is coupled to the bus 1105 for persistently storing information and instructions. Computing device 1100 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 1100 may be coupled via the bus 1105 to a display 1135, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 1130, such as a keyboard including alphanumeric and other keys, may be coupled to the bus 1105 for communicating information and command selections to the processor 1110. In another implementation, the input device 1130 may be integrated with the display 1135, such as in a touch screen display. The input device 1130 can include a cursor control, such as a mouse, a trackball, or cursor direction keys, for communicating direction information and command selections to the processor 1110 and for controlling cursor movement on the display 1135.

According to various implementations, the processes and/or methods described herein can be implemented by the computing system 1100 in response to the processor 1110 executing an arrangement of instructions contained in main memory 1115. Such instructions can be read into main memory 1115 from another computer-readable medium, such as the storage device 1125. Execution of the arrangement of instructions contained in main memory 1115 causes the computing system 1100 to perform the illustrative processes and/or method steps described herein. One or more processors in a multi-processing arrangement may also be employed to execute the instructions contained in main memory 1115. In alternative implementations, hard-wired circuitry may be used in place of or in combination with software instructions to effect illustrative implementations. Thus, implementations are not limited to any specific combination of hardware circuitry and software.

The computing system 1100 also includes a communications module 1140 that may be coupled to the bus 1105 for providing a communication link between the system 1100 and a network 1145. As such, the communications module 1140 enables the processor 1110 to communicate, wired or wireiessly, with other electronic systems coupled to the network 1145. For instance, the communications module 1140 may be coupled to an Ethernet line that connects the system 1100 to the Internet or another network 1145. In other implementations, the communications module 1140 may be coupled to an antenna (not shown) and provides functionality to transmit and receive information over a wireless communication interface with the network 1145.

In various implementations, the communications module 1140 may include one or more transceivers configured to perform data communications in accordance with one or more communications protocols such as, but not limited to, WLAN protocols (e.g., IEEE 802.11 a/b/g/n/ac/ad, IEEE 802.16, IEEE 802.20, etc.), PAN protocols, Low-Rate Wireless PAN protocols (e.g., ZigBee, IEEE 802.15.4-2003), Infrared protocols, Bluetooth protocols, EMI protocols including passive or active RFID protocols, and/or the like.

The communications module 1140 may include one or more transceivers configured to communicate using different types of protocols, communication ranges, operating power requirements, RE sub-bands, information types (e.g., voice or data), use scenarios, applications, and/or the like. In various implementations, the communications module 1140 may comprise one or more transceivers configured to support communication with local devices using any number or combination of communication standards.

In various implementations, the communications module 1140 can also exchange voice and data signals with devices using any number or combination of communication standards (e.g., GSM, CDMA, TDNM, WCDMA, OFDM, GPRS, EV-DO, WiFi, WiMAX, S02.xx, UWB, LTE, satellite, etc). The techniques described herein can be used for various wireless communication networks 150 such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network can implement a radio technology such as Universal Terrestrial Radio Access (UTRA), cdma2000, etc. UTRA includes Wideband CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

Although an example computing system 1100 has been described in FIG. 11, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a non-transitory tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The term “data processing apparatus” or “computing device” or “processing circuit” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular embodiments. Certain features described in this specification in the context of separate embodiments can also be implemented in combination in a single implementation. Conversely, various features described in the context of a single implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method for generating predicted data based on a perspective selection, the method comprising:
receiving, at a processing module, a perspective selection from a client device;
determining, using a processing module, one or more algorithms to generate predictive data based, at least in part, on the perspective selection;
determining, using a processing module, relevant data based, at least in part, on the determined one or more algorithms;
retrieving, using a processing module, the relevant data from a backend system; and
generating, using a processing module, predicted data using the one or more algorithms and the retrieved relevant data.

2. The method of claim 1 further comprising:
storing, in a predictive analysis data store, the generated predicted data; and
outputting the generated predicted data to the client device.

3. The method of claim 2, wherein the retrieving of the relevant data from the backend system includes identifying a view of a virtual data model module associated with the relevant data.

4. The method of claim 2 further comprising:
outputting one or more options to the client device based on the determined one or more algorithms;
receiving an option selection from the client device; and
determining, using a processing module, an algorithm of the one or more algorithms to generate predictive data based on the perspective selection and the option selection;
wherein the determining of the relevant data is based on the determined algorithm of the one or more algorithms.

5. The method of claim 1, wherein the perspective selection corresponds to a role in a business.

6. The method of claim 1 further comprising:
receiving, at a processing module, a second perspective selection from the client device;
determining, using a processing module, a second algorithm to generate second predictive data based, at least in part, on the second perspective selection; and
generating, using a processing module, the second predicted data using the second algorithm.

7. The method of claim 6, wherein generating the second predicted data using the second algorithm is based, at least in part, on the generated predicted data that used the one or more algorithms and the retrieved relevant data.

8. A system comprising:
a processing module; and
a non-transitory computer-readable storage device storing instructions that, when executed by the processing module, cause the processing module to perform operations comprising:
receiving a first perspective selection from a client device, wherein the perspective selection corresponds to a role in a business;
determining a first algorithm to generate first predictive data based, at least in part, on the first perspective selection;
determining relevant data based, at least in part, on the determined first algorithm;
retrieving the relevant data from a backend system;
generating first predicted data using the determined first algorithm and the retrieved relevant data; and
storing the generated first predicted data in a predictive analysis data store.

9. The system of claim 8, wherein the instructions cause the processing module to perform operations further comprising:
outputting the generated first predicted data to the client device to be displayed as part of a first visualization.

10. The system of claim 8, wherein the retrieving of the relevant data from the backend system includes identifying a view of a virtual data model module associated with the relevant data.

11. The system of claim 8, wherein the instructions cause the processing module to perform operations further comprising:
outputting one or more options to the client device based on the determined first algorithm; and
receiving an option selection from the client device;
wherein the determining of the relevant data is based on the option selection and the determined first algorithm.

12. The system of claim 8, wherein the instructions cause the processing module to perform operations further comprising:
receiving a second perspective selection from the client device;
determining a second algorithm to generate second predictive data based, at least in part, on the second perspective selection; and
generating the second predicted data using the second algorithm and the first predicted data.

13. The system of claim 12, wherein generating the second predicted data using the second algorithm is based, at least in part, on the generated predicted data that used the one or more algorithms and the retrieved relevant data.

14. The system of claim 13, wherein the instructions cause the processing module to perform operations further comprising:
outputting the generated second predicted data to the client device to be displayed as part of a second visualization.

15. A non-transitory computer-readable storage device storing instructions that, when executed by a processing module, cause the processing module to perform operations comprising:
receiving a perspective selection from a client device;
determining an algorithm to generate predictive data based, at least in part, on the perspective selection;
determining relevant data based, at least in part, on the determined algorithm;
retrieving the relevant data from a backend system, wherein the retrieving of relevant data from the backend system includes identifying a view of a virtual data model module associated with the relevant data; and
generating predicted data using the determined algorithm e retrieved relevant data.

16. The non-transitory computer-readable storage device of claim 15, wherein the perspective selection corresponds to a role in a business.

17. The non-transitory computer-readable storage device of claim 15, wherein the perspective selection is associated with a first set of algorithms, wherein each algorithm of the first set of algorithms is associated with relevant data for the each algorithm, the non-transitory computer-readable storage device storing instructions that cause the processing module to perform operations further comprising:
outputting a set of options to the client device based on the first set of algorithms; and
receiving an option selection from the client device based on the set of options outputted;
wherein the determining of the algorithm to generate predictive data is further based on the option selection, and wherein the determining of the relevant data is based on the option selection and the determined algorithm.

18. The non-transitory computer-readable storage device of claim 15, wherein the retrieving of the relevant data from the backend system includes identifying a view of a virtual data model module associated with the relevant data.

19. The non-transitory computer-readable storage device of claim 18 storing instructions that cause the processing module to perform operations further comprising:
receiving a second perspective selection from the client device;
determining a second algorithm to generate second predictive data based, at least in part, on the second perspective selection; and
generating the second predicted data using the second algorithm and the predicted data generated using the determined algorithm and the retrieved relevant data.

20. The non-transitory computer-readable storage device of claim 15 storing instructions that cause the processing module to perform operations further comprising:
outputting the generated predicted data to the client device to be displayed as part of a visualization.
